(19) United States
(12) Patent Application Publication
(10) Pub. No.: US 2007/0138890 A1
(43) Pub. Date: Jun. 21, 2007

(54) Permanent magnet type DC motor assembly

(75) Inventor: Changbum Yu, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/641,689

(22) Filed: Dec. 20, 2006

(30) Foreign Application Priority Data
Dec. 21, 2005 (KR) 10-2005-0126850

(51) Int. Cl. H02K 1/04; H02K 21/12

(52) U.S. Cl. 310/156.22; 310/43; 310/156.12

(57) ABSTRACT

A DC motor assembly includes a rotary shaft, a rotor core surrounding the rotary shaft while maintaining a specific gap from each other, a plurality of magnets arranged on an periphery surface of the rotor core, and a fixing member for fixedly engaging the magnets and the rotor core with the rotary shaft. The fixing member includes a pair of cap plates which are fixed around the rotary shaft at an upper end part and a lower end part of both of the rotor core and the magnets.

### FIELD OF THE INVENTION

The present invention relates to a permanent magnet type DC motor assembly; and more particularly to, a permanent magnet type DC motor assembly provided with a fixing member which is used for engaging magnets and a rotor core with a rotary shaft.

### BACKGROUND OF THE INVENTION

A DC motor assembly is essentially used to activate electric appliances in a household or an industrial field. Recently, there have been developed various motor assemblies capable of rotating at a high speed so as to improve task performance speed or a response speed to a user's operation.

Particularly, brushless DC Motor has been developed as a motor assembly for use in a high-speed rotation.

In such a high-speed rotatable DC motor, a rotor and magnets are engaged with a rotary shaft and rotated by the rotation of the rotary shaft. At this time, in case that the rotor and the magnets are improperly engaged with each other, there may be a concern that they are separated from each other, resulting in a motor failure.

Moreover, in case that the rotor and the magnets are engaged with each other in an unbalance state, vibration may occur while the motor assembly is operated which in turn generates noises and shortens the life time of the motor assembly.

One of the conventional permanent magnet type DC motor assemblies is shown in FIG. 1.

As shown, the conventional DC motor assembly includes a rotary shaft 10 which is rotatable at a high speed, a rotor core 20 which is attached to the rotary shaft 10 via an adhesive and is tightly fitted therearound, and permanent magnets 30 which are attached to an outer periphery of the rotor core 20.

In such a configuration, the rotor core 20 is connected to the rotary shaft 10 via an entire inner periphery and the attachment of the permanent magnets 30 to the rotor core 20 is achieved only by the adhesive.

In other words, since the contact area between the rotor core 20 and the rotary shaft 10 is large and mass of the rotor core 20 and the permanent magnets 30 is converged on the rotary shaft 10, vibration may occurs due to the unbalance of the motor assembly when the motor assembly rotates at the high speed. Furthermore, there is a drawback in that the permanent magnets 30 are deviated from the rotor core 20 to leak magnetic flux.

### SUMMARY OF THE INVENTION

It is, therefore, an object of the present invention to prevent a permanent magnet type DC motor assembly which is capable of settling rotor unbalance generated when the rotor rotates at a high speed and has an increased engagement of permanent magnets with a rotor core.

In accordance with the present invention, there is provided a DC motor assembly including: a rotary shaft; a rotor core surrounding the rotary shaft while maintaining a specific gap from each other; a plurality of magnets arranged on an periphery surface of the rotor core; and a fixing member for fixedly engaging the magnets and the rotor core with the rotary shaft.

### BRIEF DESCRIPTION OF THE DRAWINGS

The above and other objects and features of the present invention will become apparent from the following description of preferred embodiments, given in conjunction with the accompanying drawings, in which:

FIG. 1 shows a cross sectional view of a conventional permanent magnets type DC motor assembly;

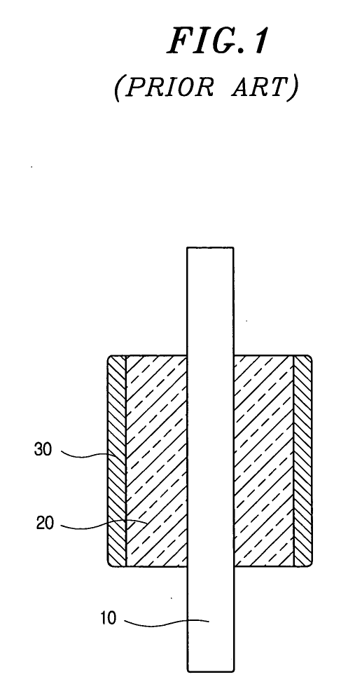

FIGS. 2 and 3 describe a cross sectional view of a DC motor assembly in accordance with an embodiment of the present invention and a plan view thereof, respectively; and

FIG. 4 illustrates a cross sectional view of a DC motor assembly in accordance with a modification of the present invention.

### DETAILED DESCRIPTION OF THE PREFERRED EMBODIMENT

Hereinafter, preferred embodiments of the present invention will be described in detail with reference to the accompanying drawings.

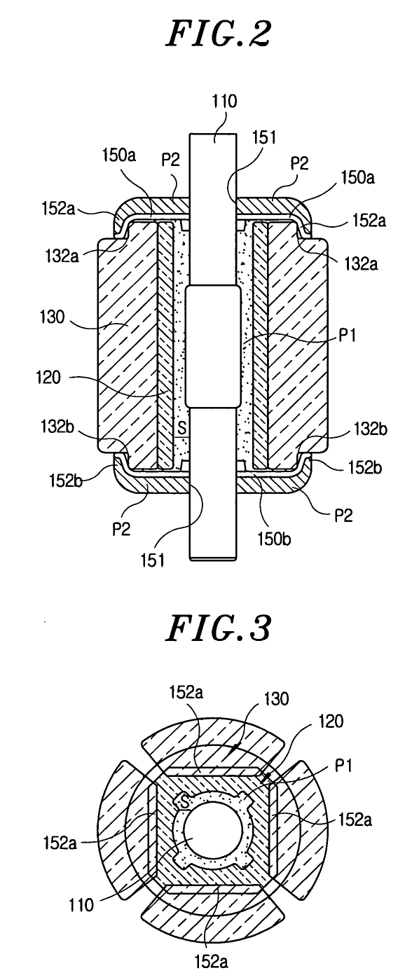

FIGS. 2 and 3 describe a cross sectional view of a DC motor assembly in accordance with a preferred embodiment of the present invention and a plan view thereof, respectively.

Referring to FIGS. 2 and 3, the DC motor assembly includes a rotary shaft 110 for performing a rotational movement, a cylindrical rotor core 120 surrounding the rotary shaft 110, a plurality of magnets 130 attached to and arranged on an outer periphery of the rotor core 120 while maintaining a preset distance therebetween. The DC motor assembly further includes an upper and a lower cap plate 150a and 150b as a fixing member for fixedly engaging the magnets 130 and the rotor core 120 with the rotary shaft 110 in a surer manner.

The rotary shaft 110 is disposed at approximately a central axis of the rotor core 120 while spaced apart from the rotor core 120 to form a specific gap S therebetween. The specific gap S is filled with a filler material P1 which is made of, e.g., resin.

The each of the magnets 130 includes an upper and a lower engagement protrusion 132a and 132b at its upper and lower end part respectively.

Each of the cap plates 150a and 150b is made of a plate-shaped spring steel having a relatively greater resilient force and is provided with a hole 151 at approximately its central portion. Furthermore, the upper and the lower cap plate 150a and 150b include an upper and a lower coupling portions 152a and 152b respectively. The cap plates 150a and 150b are fixedly coupled to the rotary shaft 110 by being fitted around the rotary shaft 110 via their corresponding holes 151 respectively while holding an upper and a lower part of an assembly of the rotor core 120 and the magnets 130 respectively.

Specifically, the upper parts of the magnets 130 are fixed to the rotary shaft 110 by the engagement of the upper engagement protrusions 132a of the magnets 130 and the upper coupling portion 152a of the upper cap plate 150a. Similarly, the lower parts of the magnets 130 are fixed to the rotary shaft 110 by the engagement of the lower engagement protrusions 132b of the magnets 130 and the lower coupling portion 152b of the lower cap plate 150b. That is, the assembly comprised of the magnets 130 and the rotary core 120 is engaged with the rotary shaft 110 while being pressed toward the rotary shaft 110 by means of the resilient cap plates 150a and 150b. This allows the assembly of the magnets 130 and the rotor core 120 to be engaged with the rotary shaft 110 in a more certain manner.

The cap plates 150a and 150b may be respectively covered by cover members P2 which are formed of, e.g., resin.

The rotary shaft 110, the rotor core 120 and the magnets 130 can be formed as a single body by allowing the specific gap S to be filled with the filler material P1 and fixing the cap plates 152a and 152b to the rotary shaft 110 by means of the cover members P2.

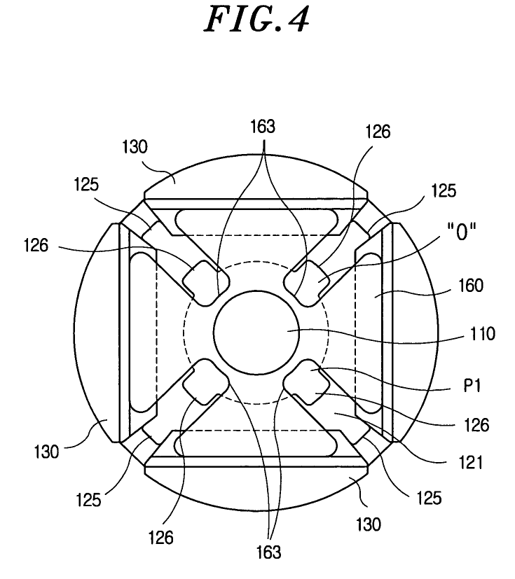

The description will now be given to another embodiment of the present invention shown in FIG. 4. The same components as illustrated in FIGS. 2 and 3 are designated by like reference numerals, with no duplicate description offered in that regard.

FIG. 4 illustrates a cross sectional view of a DC motor assembly in accordance with a modification of the present invention.

The DC motor assembly in accordance with the modification of the present invention includes a rotor core 121 which has one or more outwardly protruding side walls, e.g., four side walls 125 at an outer periphery, and a pair of cap plates 160 which are provided with one or more recesses, e.g., four recesses 163. The side walls 125 extend from top of one end thereof to bottom of the other end thereof.

When the cap plates 160 are coupled to the rotary shaft 110, the specific gap S is exposed by the recesses 163 to form exposure sections O. This allows the specific gap S to be filled with the filler material through the exposure sections O even after assembling the magnets 130 and the rotor 120 with the rotary shaft 110 by the cap plates 160.

In addition, the rotor core 121 can be provided with one or more grooves, e.g., four grooves 126 at an inner periphery. The grooves 126 are positioned between two neighboring magnets 130 to be radially aligned with the side walls 125 respectively.

When the cap plates 160 are engaged with the assembly of the magnets 130 and the rotor core 121, the grooves 125 arranged to be aligned with the recesses 163 independently to enlarge the exposure sections O. This permits the filler material P1 to fill in the specific gap S more easily. Alternatively, the formation of the grooves 125 enlarges the contact area between the filler material P1 and the rotor core 121 to thereby integrally engage the rotary shaft 110, the rotor core 121 and the magnets 130 with each other more readily.

In accordance with the present DC motor assembly, it is possible to settle the rotor unbalance generated even when the rotor rotates at a high speed. Moreover, the engagement of the rotor core and the magnets is increased.

While the invention has been shown and described with respect to the preferred embodiments, it will be understood by those skilled in the art that various changes and modification may be made without departing from the scope of the invention as defined in the following claims.

What is claimed is:

1. A DC motor assembly comprising:
a rotary shaft;
a rotor core surrounding the rotary shaft while maintaining a specific gap from each other;
a plurality of magnets arranged on an periphery surface of the rotor core; and
a fixing member for fixedly engaging the magnets and the rotor core with the rotary shaft.

2. The DC motor assembly of claim 1, wherein the fixing member includes a pair of cap plates which are fixed around the rotary shaft at an upper end part and a lower end part of both of the rotor core and the magnets.

3. The DC motor assembly of claim 2, wherein each of the cap plates is provided with a hole at approximately its central portion and coupled to the rotary shaft by being fitted around the rotary shaft via its hole.

4. The DC motor assembly of claim 2, wherein each of the magnets includes engagement protrusions at its upper and the lower end part and each of the cap plates includes a coupling portion, the magnets being supported and fixed by the fixing member by means of engagements of coupling portions and engagement protrusions.

5. The DC motor assembly of claim 1, wherein the specific gap is filled with a filler member.

6. The DC motor assembly of claim 5, wherein the filler member includes resin.

7. The DC motor assembly of claim 1, wherein the fixing member is covered with a cover member.

8. The DC motor assembly of claim 7, wherein the cover member includes resin.

9. The DC motor assembly of claim 1, wherein the fixing member is provided with one or more recesses for exposing the specific gap therethrough.

10. The DC motor assembly of claim 9, wherein the specific gap is filled with resin through said one or more recesses.

11. The DC motor assembly of claim 9, wherein the rotor core has at inner surface one or more grooves, said one or more grooves being arranged to be aligned with said one or more recesses when the rotor core is engaged with the fixing member, thereby enlarging an exposure portion of the specific gas.

12. The DC motor assembly of claim 1, wherein the rotor core includes one or more side walls at an outer periphery, the side walls being arranged between two neighboring magnets.
